(19) United States
(12) Patent Application Publication
(10) Pub. No.: US 2002/0107817 A1
(43) Pub. Date: Aug. 8, 2002

(54) CHARGING SYSTEM AND METHOD AND STORAGE MEDIUM STORING PROGRAMS OF CHARGING METHOD

(76) Inventor: NOBUYUKI NAKAJIMA, YOKOHAMA-SHI (JP)

Correspondence Address: FITZPATRICK CELLA HARPER & SCINTO, 30 ROCKEFELLER PLAZA, NEW YORK, NY, 10112, US

(21) Appl. No.: 09/178,897

(22) Filed: Oct. 27, 1998

(30) Foreign Application Priority Data
Oct. 27, 1997 (JP) 9-311392

(51) Int. Cl. G06G 7/00

(52) U.S. Cl. 705/400

(57) ABSTRACT

A charging system for executing a process of charging for a use of each of a plurality of input/output apparatuses such as scanners and printers connected to a network. The charging system includes a plurality of charge counters and a renewing unit provided for each of the plurality of input/output apparatuses, the plurality of charge counters being provided in correspondence with finely classified process contents of input/output processes, and the renewing unit renewing the charge counters corresponding to the process contents of the input/output processes executed in response to an instruction from a computer connected to the network, a plurality of collecting units for collecting counts of the charge counters of the plurality of input/output apparatuses, the counts having been renewed by the renewing unit, and a managing unit for collecting and collectively managing the counts of the charge counters collected by the plurality of collecting units together with information representative of the corresponding collecting units and information representative of the corresponding process contents of the input/output processes. Accordingly, an efficient and fine charging process can be performed in accordance with the service contents.

### BACKGROUND OF THE INVENTION

1. Field of the Invention

The present invention relates to charging techniques for executing a process of charging for a use of each of a plurality of input/output apparatuses such as scanners and printers connected to a network.

2. Related Background Art

In a system constituted of input/output apparatuses such as scanners and printers connected to a network, a charging process is performed at each of the input/output apparatuses when the apparatus is used by a client machine connected to the network.

FIG. 25 shows the configuration of a conventional charging system. Reference numeral 171 represents a network bus connected to which are a client personal computer (hereinafter called a client PC) 174, a scanner 172, a printer 173, and the like. For example, a user instructs the scanner 173 to scan an image and reads the scanned image and instructs the printer 172 to print out the read image, by using the client PC 174 connected to the network bus 171.

The scanner 173 and printer 172 are provided with their own counters 175 and 176 which count the numbers of input/output pages instructed by the client PC 174.

A service man of the company providing this system routinely goes to the client to check the counts of the counters 175 and 176 and charges for the input/output pages in accordance with the total values of the counts of the counters 175 and 176.

The conventional charging techniques are, however, associated with the following problems. It is necessary for a service man to routinely go to the client in order to check the counts and calculate the total values of the counts, so that the cost of man power increases.

Furthermore, since a counter is provided for each of scanners, printers and the like, the count collection work becomes complicated. Each counter counts input/output pages only. Therefore, for example, even if a monochrome page or a color page is output from a printer, the count number is the same and a charging process matching the service contents cannot be performed.

### SUMMARY OF THE INVENTION

It is an object of the present invention to solve the above problems and provide an efficient and fine charging process properly matching the service contents.

In order to achieve the above object, an embodiment of the invention provides a charging system for executing a process of charging for a use of each of a plurality of input/output apparatuses such as scanners and printers connected to a network, the charging system comprising: a single charge counter and renewing means provided for each of the plurality of input/output apparatuses, the renewing means renewing the charge counter when an input/output process is executed in response to an instruction from a computer connected to the network; and summing means for summing up counts of the charge counters of the plurality of input/output apparatuses, the counts having been renewed by the renewing means.

Another embodiment of the invention provides a charging system for executing a process of charging for a use of each of a plurality of input/output apparatuses such as scanners and printers connected to a network, the charging system comprising: a single charge counter and renewing means provided for each of the plurality of input/output apparatuses, the renewing means renewing the charge counter when an input/output process is executed in response to an instruction from a computer connected to the network; and collecting means for collecting counts of the charge counters of the plurality of input/output apparatuses, the counts having been renewed by the renewing means.

Another embodiment of the invention provides a charging system for executing a process of charging for a use of each of a plurality of input/output apparatuses such as scanners and printers connected to a network, the charging system comprising: a plurality of charge counters and renewing means provided for each of the plurality of input/output apparatuses, the plurality of charge counters being provided in correspondence with finely classified process contents of input/output processes, and the renewing means renewing the charge counters corresponding to the process contents of the input/output processes executed in response to an instruction from a computer connected to the network; and collecting means for collecting counts of the charge counters of the plurality of input/output apparatuses, the counts having been renewed by the renewing means.

Another embodiment of the invention provides a charging system for executing a process of charging for a use of each of a plurality of input/output apparatuses such as scanners and printers connected to a network, the charging system comprising: a plurality of charge counters and renewing means provided for each of the plurality of input/output apparatuses, the plurality of charge counters being provided in correspondence with finely classified process contents of input/output processes and with users, and the renewing means renewing the charge counters corresponding to the process contents of the input/output processes executed in response to an instruction from a computer connected to the network and corresponding to the users; and collecting means for collecting counts of the charge counters of the plurality of input/output apparatuses, the counts having been renewed by the renewing means.

Another embodiment of the invention provides a charging system for executing a process of charging for a use of each of a plurality of input/output apparatuses such as scanners and printers connected to a network, the charging system comprising: a single charge counter and renewing means provided for each of the plurality of input/output apparatuses, the renewing means renewing the charge counter by a count-up amount corresponding to process contents of input/output processes executed in response to an instruction from a computer connected to the network; and collecting means for collecting counts of the charge counters of the plurality of input/output apparatuses, the counts having been renewed by the renewing means.

Another embodiment of the invention provides a charging method for executing a process of charging for a use of each of a plurality of input/output apparatuses such as scanners and printers connected to a network, the charging method comprising the steps of: renewing a single charge counter provided in each of the plurality of input/output apparatuses, when an input/output process is executed in response to an instruction from a computer connected to the network; and summing up counts of the charge counters of the plurality of input/output apparatuses, the counts having been renewed by the renewing step.

Another embodiment of the invention provides a charging system for executing a process of charging for a use of each of a plurality of input/output apparatuses such as scanners and printers connected to a network, the charging method comprising the steps of: renewing a single charge counter provided in each of the plurality of input/output apparatuses when an input/output process is executed in response to an instruction from a computer connected to the network; and collecting counts of the charge counters of the plurality of input/output apparatuses, the counts having been renewed by the renewing step.

Another embodiment of the invention provides a charging method for executing a process of charging for a use of each of a plurality of input/output apparatuses such as scanners and printers connected to a network, the charging method comprising the steps of: renewing a plurality of charge counters provided in each of the plurality of input/output apparatuses in correspondence with finely classified process contents of input/output processes, the renewed charge counters corresponding to the process contents of the input/output processes executed in response to an instruction from a computer connected to the network; and collecting counts of the charge counters of the plurality of input/output apparatuses, the counts having been renewed by the renewing steps.

Another embodiment of the invention provides a charging method for executing a process of charging for a use of each of a plurality of input/output apparatuses such as scanners and printers connected to a network, the charging method comprising the steps of: renewing a plurality of charge counters provided in each of the plurality of input/output apparatuses in correspondence with finely classified process contents of input/output processes and with users, the renewed charge counters corresponding to the process contents of the input/output processes executed in response to an instruction from a computer connected to the network and corresponding to the users; and collecting counts of the charge counters of the plurality of input/output apparatuses, the counts having been renewed by the renewing means.

Another embodiment of the invention provides a charging method for executing a process of charging for a use of each of a plurality of input/output apparatuses such as scanners and printers connected to a network, the charging method comprising the steps of: renewing a single charge counter provided in each of the plurality of input/output apparatuses by a count-up amount corresponding to process contents of input/output processes executed in response to an instruction from a computer connected to the network; and collecting counts of the charge counters of the plurality of input/output apparatuses, the counts having been renewed by the renewing means.

Another embodiment of the invention provides a storage medium storing a program for executing a process of charging for a use of each of a plurality of input/output apparatuses such as scanners and printers connected to a network, the program storing: a renewing routine for renewing a single charge counter provided in each of the plurality of input/output apparatuses, when an input/output process is executed in response to an instruction from a computer connected to the network; and a summing routine for summing up counts of the charge counters of the plurality of input/output apparatuses, the counts having been renewed by the renewing step.

Another embodiment of the invention provides a storage medium storing a program for executing a process of charging for a use of each of a plurality of input/output apparatuses such as scanners and printers connected to a network, the program storing: a renewing routine for renewing a single charge counter provided in each of the plurality of input/output apparatuses when an input/output process is executed in response to an instruction from a computer connected to the network; and a collecting routine for collecting counts of the charge counters of the plurality of input/output apparatuses, the counts having been renewed by the renewing routine.

Another embodiment of the invention provides a storage medium storing a program for executing a process of charging for a use of each of a plurality of input/output apparatuses such as scanners and printers connected to a network, the program storing: a renewing routine for renewing a plurality of charge counters provided in each of the plurality of input/output apparatuses in correspondence with finely classified process contents of input/output processes, the renewed charge counters corresponding to the process contents of the input/output processes executed in response to an instruction from a computer connected to the network; and a collection routine for collecting counts of the charge counters of the plurality of input/output apparatuses, the counts having been renewed by the renewing routine.

Another embodiment of the invention provides a storage medium storing a program for executing a process of charging for a use of each of a plurality of input/output apparatuses such as scanners and printers connected to a network, the program storing: a renewing routine for renewing a plurality of charge counters provided in each of the plurality of input/output apparatuses in correspondence with finely classified process contents of input/output processes and with users, the renewed charge counters corresponding to the process contents of the input/output processes executed in response to an instruction from a computer connected to the network and corresponding to the users; and a collection routine for collecting counts of the charge counters of the plurality of input/output apparatuses, the counts having been renewed by the renewing routine.

Another embodiment of the invention provides a storage medium storing a program for executing a process of charging for a use of each of a plurality of input/output apparatuses such as scanners and printers connected to a network, the program storing: a renewing routine for renewing a single charge counter provided each of the plurality of input/output apparatuses by a count-up amount corresponding to process contents of input/output processes executed in response to an instruction from a computer connected to the network; and a collecting routine for collecting counts of the charge counters of the plurality of input/output apparatuses, the counts having been renewed by the renewing routine.

Another embodiment of the invention provides a system for executing a process of charging for a use of each of a plurality of input/output apparatuses connected to a network, the input/output apparatus having a charge counter and renewing means for renewing the charge counter when an input/output process or an environment setting process is executed in response to an instruction from a computer connected to the network, the charging system comprising: summing means for summing up counts of the charge counters of the plurality of input/output apparatuses, the counts having been renewed by the renewing means.

Another embodiment of the invention provides a charging method for executing a process of charging for a use of each of a plurality of input/output apparatuses connected to a network, the input/output apparatus having a charge counter and renewing means for renewing the charge counter when an input/output process or an environment setting process is executed in response to an instruction from a computer connected to the network, the charging method comprising the step of: summing up counts of the charge counters of the plurality of input/output apparatuses, the counts having been renewed by the renewing means.

Another embodiment of the invention provides a storage medium storing a program for executing a process of charging for a use of each of a plurality of input/output apparatuses connected to a network, the input/output apparatus having a charge counter and renewing means for renewing the charge counter when an input/output process or an environment setting process is executed in response to an instruction from a computer connected to the network, the program storing: a summing routine for summing up counts of the charge counters of the plurality of input/output apparatuses, the counts having been renewed by the renewing means.

Another embodiment of the invention provides a charging system comprising: processing means for processing data; setting means provided for performing an environment setting process for data processing; and charging means for charging in accordance with a processing operation by the processing means and/or the setting means.

Another embodiment of the invention provides a charging method comprising: a processing step of processing data; a setting step provided for performing an environment setting process for data processing; and a charging step of charging in accordance with a processing operation by the processing step and/or the setting step.

Another embodiment of the invention provides a storage medium storing a program, the program storing: a processing routine for processing data; a setting routine provided for performing an environment setting process for data processing; and a charging routine for charging in accordance with a processing operation by the processing routine and/or the setting routine.

### BRIEF DESCRIPTION OF THE DRAWINGS

FIG. 1 is a diagram showing the configuration of a network system using a charging system according to a first embodiment of the invention.

FIGS. 2A and 2B are flow charts illustrating input/output instructions by a client PC and a flow of information on a network.

FIG. 3 is a flow chart illustrating a process to be executed by a scanner.

FIG. 4 is a flow chart illustrating a process to be executed by a printer.

FIG. 5 is a diagram showing a display example of a user interface when a scanner is selected, according to the first embodiment.

FIG. 6 is a diagram showing a display example of a user interface when a printer is selected, according to the first embodiment.

FIG. 7 is a flow chart illustrating a process to be executed by a charge server.

FIG. 8 is a flow chart illustrating a process to be executed by a service center machine.

FIG. 9 is a conceptual diagram showing an example of the counts by counters in a scanner, according to a second embodiment of the invention.

FIG. 10 is a conceptual diagram showing an example of the counts by counters in a printer, according to the second embodiment of the invention.

FIG. 11 is a diagram showing a display example of a graphical user interface when a scanner is selected, according to the second embodiment.

FIG. 12 is a diagram showing a display example of a graphical user interface including function charges when a scanner is selected, according to the second embodiment.

FIG. 13 is a diagram showing a display example of a graphical user interface when a printer is selected, according to the second embodiment.

FIG. 14 is a diagram showing a display example of a graphical user interface including function charges when a printer is selected, according to the second embodiment.

FIG. 15 is a conceptual diagram showing unit price information for each counter of a scanner, according to the second embodiment.

FIG. 16 is a conceptual diagram showing unit price information for each counter of a printer, according to the second embodiment.

FIG. 17 is a conceptual diagram showing an example of each counter in a scanner according to a third embodiment of the invention.

FIG. 18 is a flow chart illustrating a process to be executed by a scanner according to the third embodiment.

FIG. 19 is a block diagram showing an example of the configuration of a charging system according to a fourth embodiment of the invention.

FIG. 20 is a flow chart illustrating a process to be executed by a calibration server constituting the charging system according to the fourth embodiment of the invention.

FIG. 21 is a graph illustrating printer calibration according to the fourth embodiment of the invention.

FIG. 22 is a flow chart illustrating a detailed process to be executed by the calibration server constituting the charging system according to the fourth embodiment of the invention.

FIG. 23 is an example of a charge table according to the fourth embodiment of the invention.

FIG. 24 is a diagram showing a display example of a user interface containing function charges when a printer is set, according to the fourth embodiment of the invention.

FIG. 25 is a diagram showing a conventional charging system.

### DETAILED DESCRIPTION OF THE PREFERRED EMBODIMENTS

Embodiments of the invention will be described in detail with reference to the accompanying drawings. In each embodiment to be described below, printers and scanners are used as examples of apparatuses constituting a charging system. A charging system constituted of other apparatuses such as file servers may be obviously reduced in practice. Also in each embodiment, although a system configured on a network is used, a local environment may be reduced in practice. Although the interconnection and protocol of a network are not specifically described, any network may be used.

(First Embodiment)

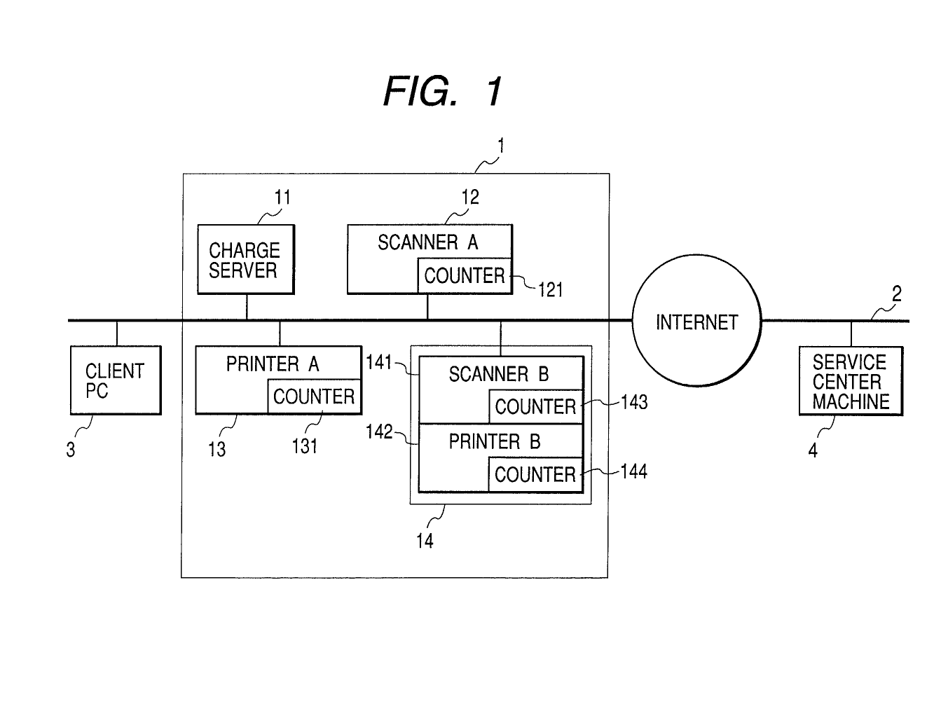

FIG. 1 shows the configuration of a network system adopting a charging system according to the first embodiment of the invention. Referring to FIG. 1, reference numeral 1 represents an input/output system and charging system (hereinafter called an input/output charging system). The input/output charging system 1 is provided for each institution such as a company. Although only one input/output charging system is shown in FIG. 1, a plurality of input/output charging systems may be connected to a network bus 2. The network bus 2 may be the Internet.

Reference numeral 3 represents a client PC of a user which receives the services of the input/output charging system 1. The client PC 3 is used for giving an input/output apparatus an instruction or for editing an input/output image through an application. A plurality of client PCs may be connected to the input/output charging system 1. Reference numeral 4 represents a service center machine made of a computer. The service center machine 4 collects charge information from a charge server to be described later and manages charge information.

In the input/output charging system 1, reference numeral 11 represents the charge server made of a computer and having a function of periodically referring to charge counters of each apparatus to be described later and collecting the counts of respective counters. Reference numeral 12 represents a scanner A having a function of performing a scan operation upon reception of an instruction from the client PC 3. Reference numeral 121 represents a counter whose count is renewed each time the scanner A 12 scans one page. This scanner A 12 also has a function of transmitting scanned image data to the instructing client PC 3 via the network 2.

Reference numeral 13 represents a printer A having a function of performing a print operation upon reception of an instruction from the client PC 3. Reference numeral 131 represents a counter whose count is renewed each time the printer A 13 prints one page. Reference numeral 14 represents a composite apparatus (copier) constituted of a scanner B 141 and a printer B 142. The composite apparatus 14 not only operates as a copier, but also operates independently as input/output apparatuses. Similar to the scanner A 12, the scanner B 141 has a function of performing a scan operation upon reception of an instruction from the client PC 3. Reference numeral 143 represents a counter whose count is renewed each time the scanner B 141 scans one page. The scanner B 141 also has a function of transmitting scanned image data to the instructing client PC 3 via the network. Similar to the printer A 13, the printer B 142 has a function of performing a print operation upon reception of an instruction from the client PC 3. Reference numeral 144 represents a counter whose count is renewed each time the printer B 142 prints one page.

Although not shown in FIG. 1 because of obviousness, the client PC 3, service center machine 4, charge server 11, scanner A 12, printer A 13, composite apparatus 14 each have an external storage unit for storing programs which execute the above-described processes and various other processed to be described later, a storage medium such as a ROM, and a central processing unit such as a CPU for executing the programs.

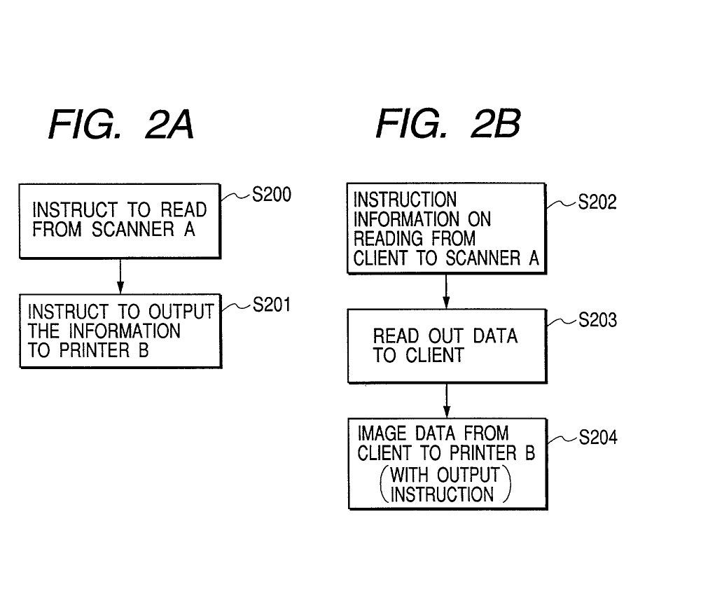

Next, instructions to be issued from the client PC 3 when an input/output process is executed and a flow of information on the network 2 will be described with reference to FIGS. 2A and 2B.

For example, first, the client PC 3 instructs the scanner A 12 to read an input image (Step S200). In response to this instruction, a read instruction group is transmitted over the network 2 from the client PC 3 to the scanner A 12 (Step S202), and then the scan image data read by the scanner A 12 is transmitted back to the client PC 3 (Step S203).

Next, the client PC 3 instructs the printer B 142 to output the scan image data (Step S201). In response to this instruction, an output instruction group is transmitted over the network 2 from the client PC 3 to the printer B 142 (Step S204).

The process flow at the scanner A 12 in the above example shown in FIGS. 2A and 2B will be described with reference to FIG. 3. First, at Step S30 it is checked whether an instruction issued from the client PC 3 to the scanner A 12 flows on the network 2. If not, the flow returns to Step S30, whereas if the instruction flows on the network 2, the instruction is analyzed and also the fact that the instruction was issued from the client PC 3 is stored, at Step S31. In accordance with the instruction analyzed at Step S31, a scan operation is executed at Step S32. Next, at Step S33 the read scan image data is transmitted to the instructing client PC 3. Next, at Step S34 the count of the counter 121 is renewed in accordance with the number of scanned pages. Thereafter, the flow returns to Step S30.

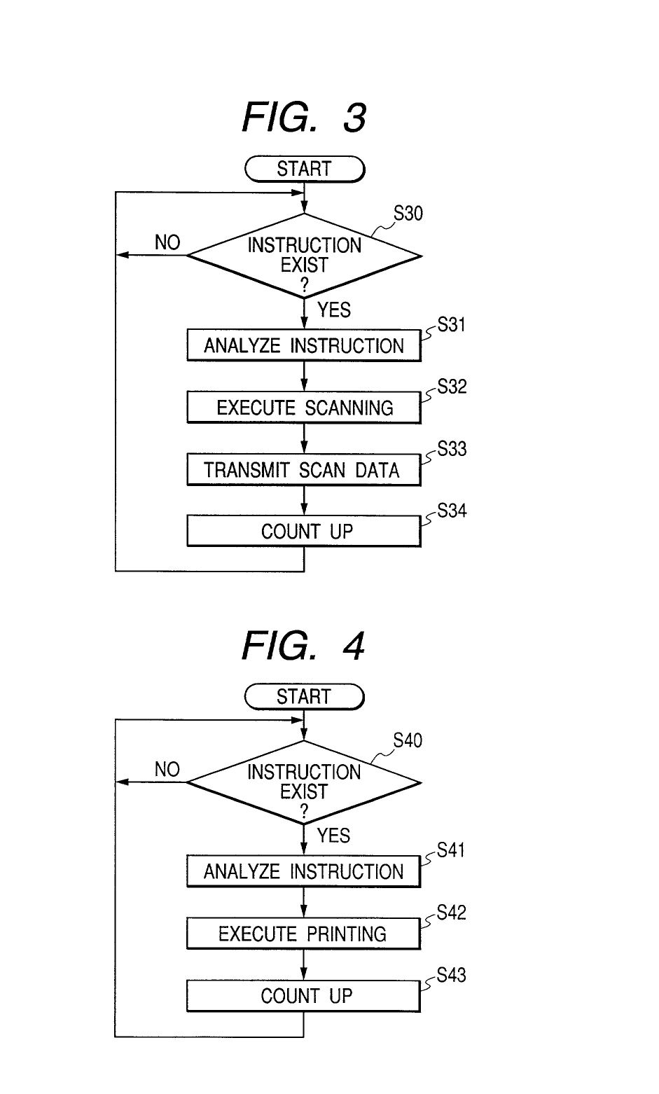

The process flow at the printer B 142 in the above example shown in FIGS. 2A and 2B will be described with reference to FIG. 4. First, at Step S40 it is checked whether an instruction issued from the client PC 3 to the printer B 142 flows on the network 2. If not, the flow returns to Step S40, whereas if the instruction flows on the network 2, the instruction is analyzed and also the fact that the instruction was issued from the client PC 3 is stored, at Step S41. In accordance with the instruction analyzed at Step S41, a print operation is executed at Step S42. Next, at Step S43 the count of the counter 144 is renewed in accordance with the number of printed pages. Thereafter, the flow returns to Step S40.

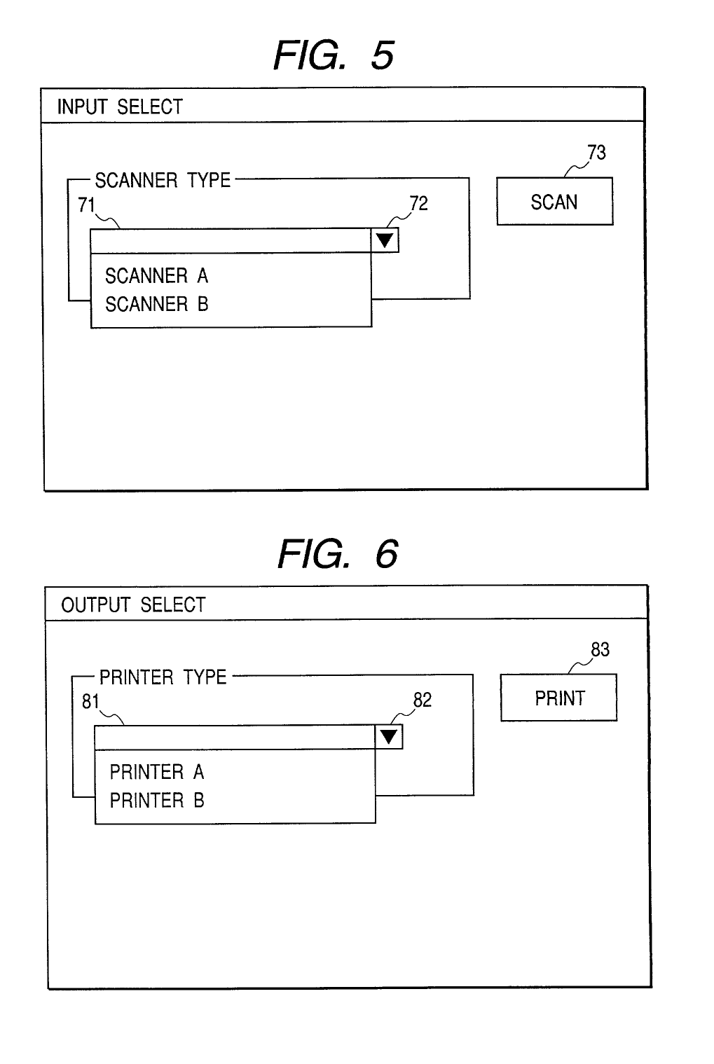

Next, display examples of a graphical user interface for an input/output instruction by the client PC 3 will be described with reference to FIGS. 5 and 6.

FIG. 5 shows a display example when an input apparatus or scanner is selected. Selection is conducted by using a pointing device such as a mouse (also in the case of FIG. 6). Referring to FIG. 5, reference numeral 71 represents a pull-down menu. When a pull-down button 72 is depressed, a list of scanners currently constituting the system is displayed. A user selects a desired scanner from this list. Thereafter, a scan button 73 is depressed so that a scan instruction group to the selected scanner flows from the client PC 3 onto the network 2.

FIG. 6 shows a display example when an output apparatus or printer is selected. Referring to FIG. 6, reference numeral 81 represents a pull-down menu. When a pull-down button 82 is depressed, a list of printers currently constituting the system is displayed. A user selects a desired printer from this list. Thereafter, a print button 83 is depressed so that a print instruction group to the selected printer flows from the client PC 3 onto the network 2.

Next, the operation of the charge server 11 will be described with reference to FIG. 7. First, at Step S50 it is judged whether or not it is a charge information collection time. This judgement is made based on an internal timer (not shown). If it is judged that it is still not the collection time, the flow returns to Step S50, whereas if it is the collection time, at Step S51 a charge information collection is performed.

In this embodiment, the counts of the counters 121, 131, 143, and 144 are collected and summed up. In this case, it is preferable that the total value of the counts is multiplied by a predetermined unit price per page to calculate the actual total charge money. Instead of summing up (totalling) the collected counts at the charge server 11, the charge server 11 may send the counts and ID information of the charge server 11 to the service center 4 to make the latter sum up the counts.

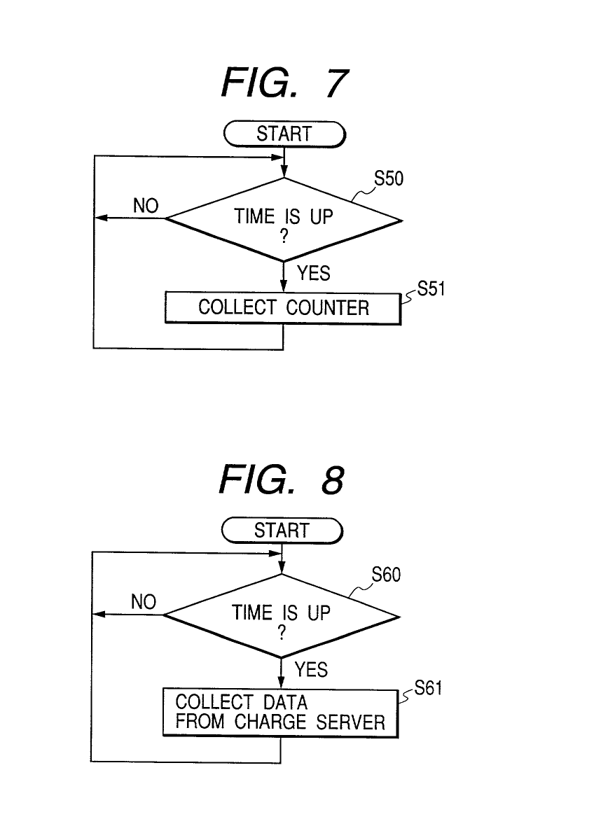

Next, the operation of the service machine 4 will be described with reference to FIG. 8. First, at Step S60 it is checked whether or not it is a charge information collection time. If it is judged that it is still not the collection time, the flow returns to Step S60, whereas if it is the collection time, at Step S61 the charge information (total value of counts, or total charge money, ID information of the charge server 11, and the like) is collected from a single charge server 11 or a plurality of charge servers 11.

In this embodiment described above, the charge server periodically collects the charge information such as the counts of counters of each apparatus under management of the charge server. Therefore, even if the service center 4 is not provided, it is not necessary for an employee or the like of the system provider to check and sum up the counts of respective counters. The sum-up work is not necessary so that the work time can be shortened and the cost of man power can be reduced. If the service center 4 is provided, this service center 4 periodically collects the charge information such as the counts of counters of each apparatus collected by the charge server 11. Therefore, it is not necessary for an employee or the like of the system provider to routinely go to the client and check and sum up the counts of the counters of each apparatus, or check the total charge money of each apparatus collected at the charge server 11. An efficient charge work can therefore be realized and the cost of man power can be reduced considerably.

(Second Embodiment)

Next, the second embodiment of the invention will be described in detail.

In the first embodiment, the counter of each apparatus constituting the input/output charging system is renewed in the unit of input/output page. In the second embodiment, the count of the counter is renewed to charge for a use of each apparatus in accordance with the details of service contents (function, process contents) at the apparatus.

The fundamental configuration of the charging system of the second embodiment is therefore similar to that of the first embodiment. The different points of the second embodiment from the first embodiment reside in that the counters of each apparatus constituting the input/output charging system 1 are specific to the functions of the apparatus, that the details of charge information specific to the functions of each apparatus is displayed when the client PC 3 issues an input/output instruction, and that the charge server 11 collects detailed charge information. These different points from the first embodiment will be described below.

In the first embodiment, the counter is incremented each time one page is input or output in order to acquire page information. In the second embodiment, a plurality of counters are prepared in each input/output apparatus in accordance with the service contents (process contents) provided by the apparatus.

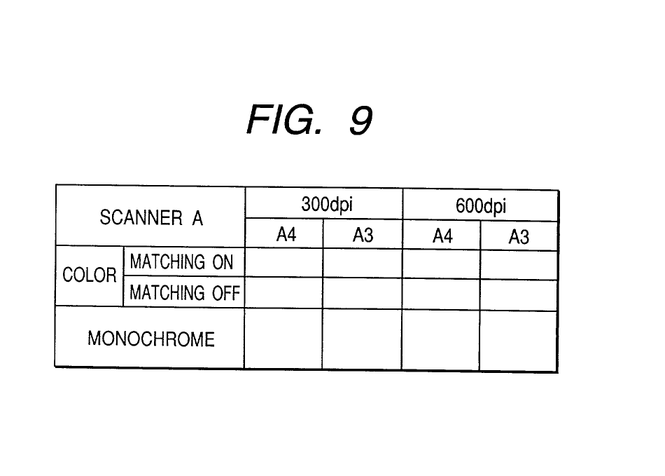

For example, as shown in FIG. 9 if the scanner A 12 has the selectable functions including a color mode/a monochrome mode, a color matching on/off for making an original color and a display color be coincident in the color mode, input resolutions of 300 dpi/600 dpi, and input sizes of A4/A3, then counters same in number as the number of combinations of these functions are prepared. The counters corresponding to the executed functions designated by the client PC 3 are incremented.

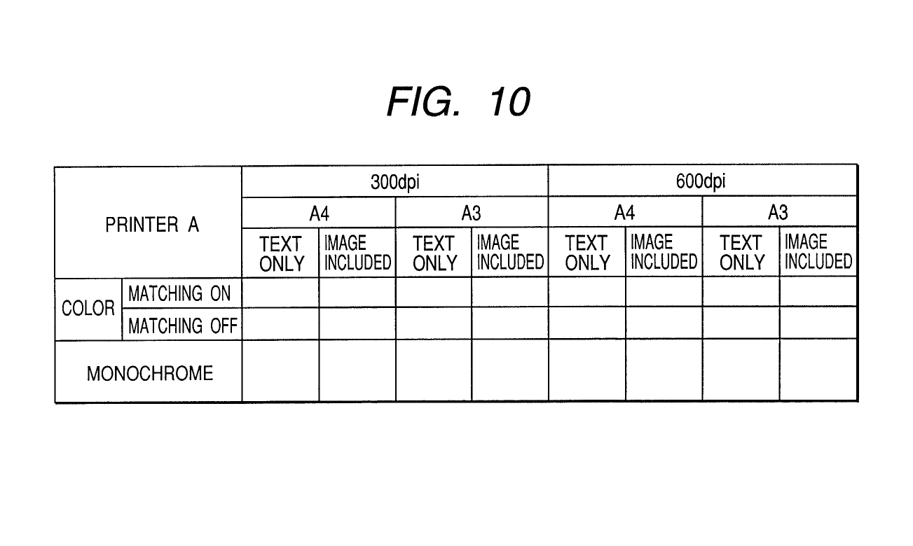

For example, as shown in FIG. 10 if the printer A 13 has the selectable functions including a color mode/a monochrome mode, a color matching on/off for making an original color and a display color be coincident in the color mode, output resolutions of 300 dpi/600 dpi, output sizes of A4/A3, and output modes of text only/image included, then counters same in number as the number of combinations of these functions are prepared. The counters corresponding to the executed functions designated by the client PC 3 are incremented.

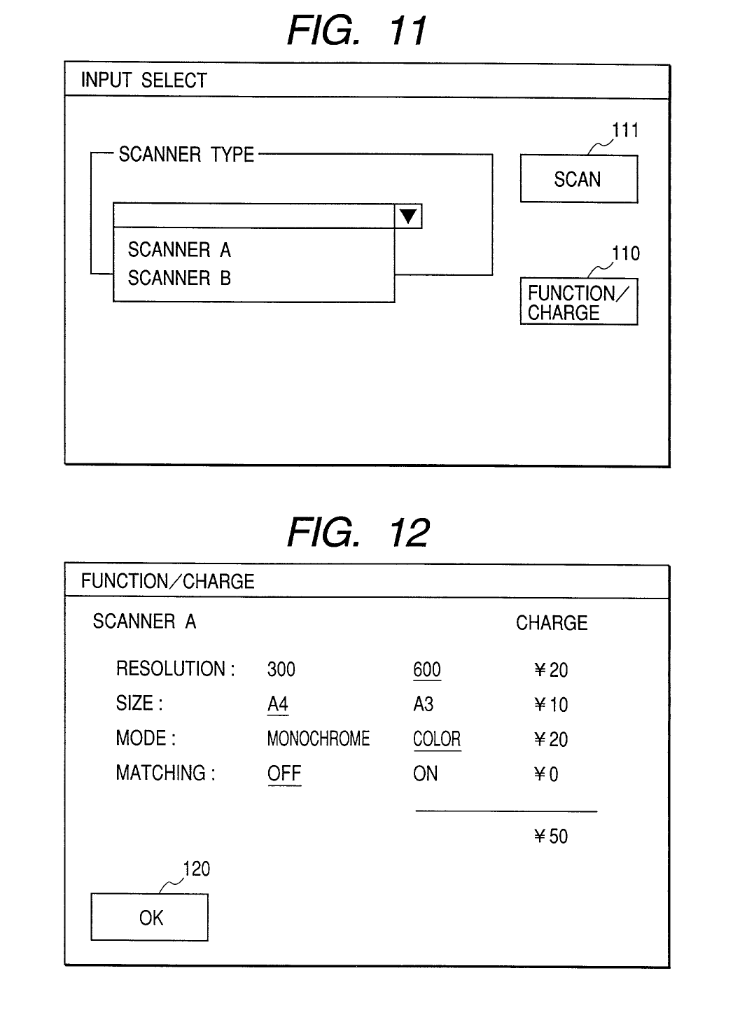

Display examples of a graphical user interface when an input/output instruction is executed by the client PC 3 will be described with reference to FIGS. 11 to 14.

FIG. 11 is a display example of a graphical user interface when a scanner is selected. Referring to FIG. 11, this display example is the same as the first embodiment excepting that a function/charge button 110 is added. In this example, it is assumed that the scanner A 12 is selected.

When the function/charge button 110 is depressed, a window shown in FIG. 12 is displayed. In this window, a correspondence between charges and functions provided by the scanner A 12 is shown. When a user selects some functions, the charge for the functions are calculated and displayed. In the display example shown in FIG. 12, the functions with an underline, 600 dpi, A4, color mode, and color matching-off are selected, which are given the charges of 20 Yen, 10 Yen, 20 Yen, and 0 Yen, respectively, and the total charge is 50 Yen. If the color matching-on is selected, this function requires a charge of 10 Yen and the total charge changes to 60 Yen.

When an OK button 120 is depressed, the display example of FIG. 11 is again displayed. When the scan button 111 is depressed, the scan instruction group including the function setting contents issued to the selected scanner A 12 from the client PC 3 flows on the network 2.

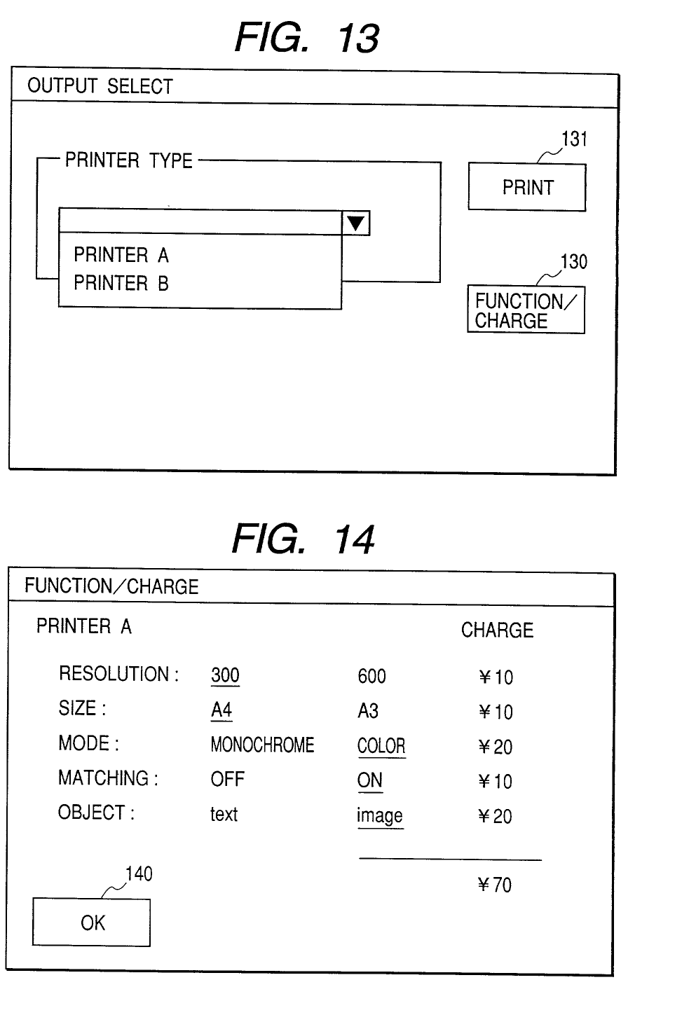

FIG. 13 is a display example of a graphical user interface when an output apparatus or printer is selected.

Referring to FIG. 13, this display example is the same as the first embodiment excepting that a function/charge button 130 is added. In this example, it is assumed that the printer A 13 is selected.

When the function/charge button 130 is depressed, a window shown in FIG. 14 is displayed. In this window, a correspondence between charges and functions provided by the printer A 13 is shown. When a user selects some functions, the charge for the functions are calculated and displayed. In the display example shown in FIG. 14, the functions with an underline, 300 dpi, A4, color mode, color matching-on, and image included are selected, which are given the charges of 10 Yen, 10 Yen, 20 Yen, 10 Yen, and 20 Yen, respectively, and the total charge is 70 Yen. If the color matching-off is selected, since this function does not requires a charge, the total charge changes to 60 Yen.

When an OK button 140 is depressed, the display example of FIG. 13 is again displayed. When the print button 131 is depressed, the print instruction group including the function setting contents issued to the selected printer A 13 from the client PC 3 flows on the network 2.

The process flow when an input/output operation is performed upon an instruction from the client PC 3 is the same as the first embodiment described with reference to FIGS. 2A and 2B and FIG. 3.

Next, the operation of the charge server 11 according to the second embodiment will be described. In the first embodiment, only the page count information is collected as the charge information. In the second embodiment, charge information such as the counts of various counters prepared in accordance with the above-described service contents is collected.

In this case, a predetermined unit price of each service function is multiplied by the counts to calculate the actual charge money. Examples of unit price information of each service function will be described.

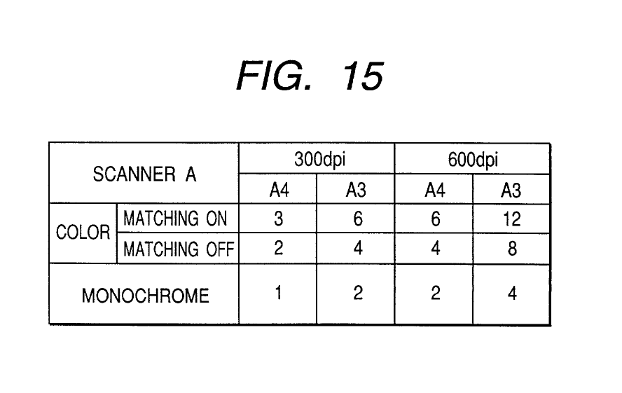

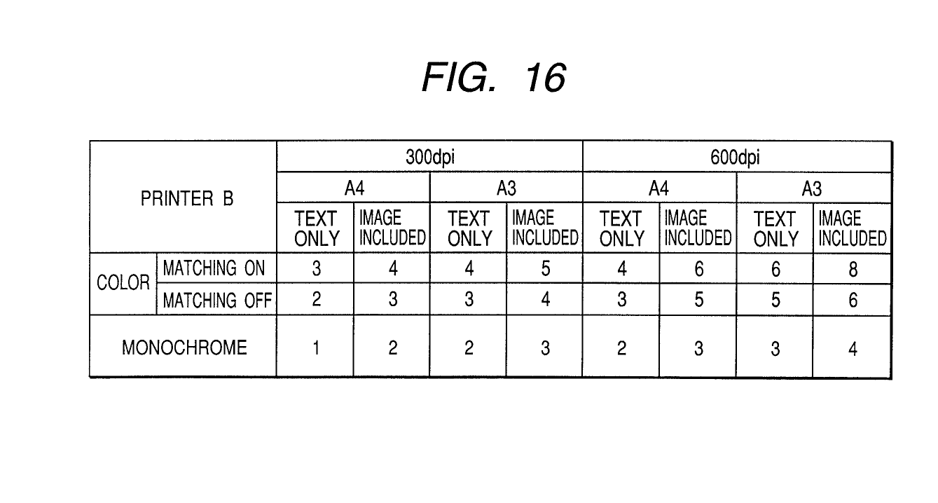

FIG. 15 shows an example of a charge table assigned to the scanner A 13. Referring to FIG. 15, for example, if the functions (color, matching-on, 300 dpi, and A4) are set, a weight “3” is given to the count. In this example, if A4 is changed to A3, the weight is “6”. The unit prices of these charges are assumed to be 30 Yen and 60 Yen which are a tenfold of the weight values. FIG. 16 shows an example of a charge table assigned to the printer B 142. Similar to FIG. 15, the items of the table are set in accordance with the printer functions.

As above, a charge is determined from the charge table of the service functions and from the count of each counter. In this case, an actual charge money may be calculated either by the charge server 11 or by the service center machine 4. If the actual charge money is to be calculated by the charge server 11, each counter value is multiplied by the corresponding weight, and the service center machine 4 is made to collect the multiplied value preferably together with the ID information of the charge server 11 and the process contents corresponding to the count.

If the actual charge money is to be calculated by the service center machine 4, it is required that the service center machine 4 should collect each count always accompanied with the ID information of the charge server 11 and the process contents corresponding to the count. The reason of always accompanying the process contents corresponding to the count is to allow the service center machine 4 to perform the above weighting process, and the reason of always accompanying the ID information of the charge server 11 is to allow the service center machine 4 to identify the charging destination client.

The charge information may be collected by the service center machine 4 by directly transmitting the charges shown in FIGS. 12 and 14 presented to a user from the client PC 3 to the service center machine 4.

The operation of the service center machine 4 is the same as the first embodiment.

In the second embodiment described above, a plurality of charge counters are prepared for each apparatus in accordance with the service contents (process contents) which are more in detail than the first embodiment, and the counts of respective counters are renewed in accordance with the contents of actually executed processes. Accordingly, a detailed charging system can be provided to each user and an efficient charging becomes possible.

(Third Embodiment)

Next, the third embodiment of the invention will be described in detail.

In the third embodiment, the charging process is performed in accordance with the detailed service contents (process contents) similar to the second embodiment, independently for each client PC 3.

Specifically, in the first embodiment, it is not necessary for a service man to routinely go to the client PC 3 so that the efficient charging becomes possible. In the second embodiment, a charging can be performed in accordance with the detailed service contents. However, the following problem arises in the first and second embodiments. Namely, in the first and second embodiments, the charge information is collected by the charge server 11 in the unit of one input/output charging system 1 and the collected charge information is summed up by the service center machine 4. In this case, the charge information for each of a plurality of client PCs 3 in one input/output charging system 1 cannot be collected so that it is not possible to independently charge each client PC 3.

It is therefore desired that the charge information should be collected independently for each of a plurality of client PCs 3 connected to the input/output charging system 1. In the third embodiment, therefore, the detailed charge information similar to the second embodiment is collected for each client PC 3 to independently charge each client PC 3.

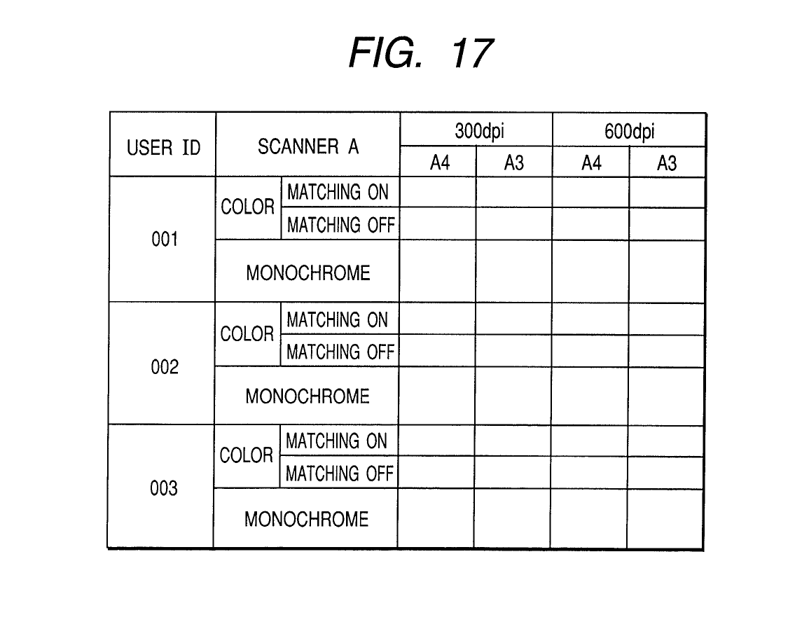

The different points of the third embodiment from the second embodiment will be described below. FIG. 17 is a conceptual diagram illustrating an example of the configuration of counters of each apparatus constituting the input/output charging system according to the third embodiment. In this example, the configuration of counters in the scanner A 12 is shown. As shown in FIG. 17, in the third embodiment, counters similar to those of the second embodiment shown in FIG. 9 are provided independently for ID data of each client PC 3.

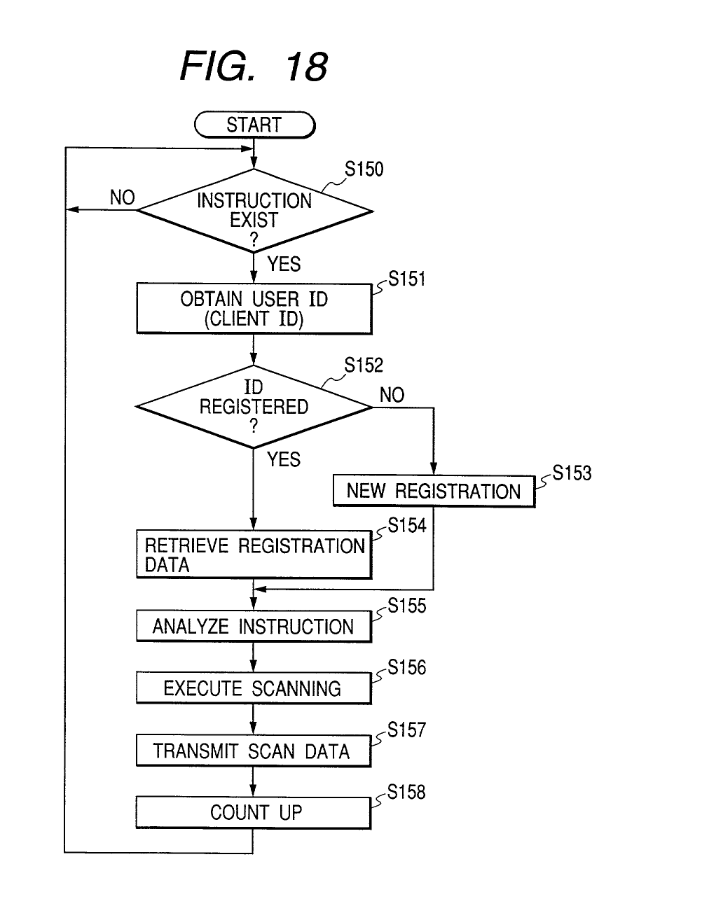

FIG. 18 is a flow chart illustrating the operation to be executed by a scanner according to the third embodiment.

First, at Step S150 it is checked whether an instruction issued from the client PC 3 to the scanner flows on the network 2. If not, the flow returns to Step S150, whereas if the instruction flows on the network 2, the ID data of the client PC is obtained at Step S151. The ID data of the client PC 3 may be any unique value in the input/output charging system 1, for example, the IP address itself of the client PC 3 may be used as the ID data.

At the next Step S152 it is checked whether the obtained ID data of the client PC 3 is already registered. If not, at Step S153 a new counter field corresponding to the ID data is formed. If the ID data is already registered, at Step S154 the registered data is read. Next, at Step S155 the instruction is analyzed. At Step S156 a scan operation is performed in accordance with the analyzed instruction. At the next Step S157 the read scan image data is transmitted to the client PC 3. Next, at Step S158 the counts of the counters corresponding to the process contents executed in accordance with the analyzed instruction and corresponding to the ID data of the client PC 3, are renewed. Thereafter, the flow returns to Step S150.

The charge server 11 collects the counts of counters of the client PCs 3 independently for each client PC 3. It is therefore possible to perform a detailed charging in accordance with the service contents, independently for each client PC 3. The service center machine 4 collects the counts of counters summed up for each client PC 3, independently for each client PC 3. It is therefore unnecessary for a service man to go to each client. In the third embodiment, it is necessary to provide the ID data of each client PC 3 in addition to the information described with the second embodiment.

The invention is not limited only to the above embodiments. For example, the embodiments can be applied to a network having only one input/output apparatus connected thereto. In the second and third embodiments, one counter may be provided to one input/output apparatus without providing a plurality of counters to each input/output apparatus. In this case, for example, the count of one counter is incremented by a weight corresponding to the process contents such as shown in FIGS. 15 and 16. It is therefore possible to considerably reduce the work of the summing process to be executed by the charge server 11. However, in this case, although the fine charging can be made in accordance with the process contents, the charge money for each of the process contents cannot be calculated.

(Fourth Embodiment)

The fourth embodiment of the invention will be described in detail below.

In the second embodiment, the count of a counter is renewed in accordance with the service contents corresponding to the set items specific to each apparatus, to thereby charge the client PC. In contrast, in the fourth embodiment, the count of a counter is renewed in accordance not only with the set items specific to each apparatus, but also with whether a service (hereinafter called calibration) for stabilizing the operation environment of the apparatus is used or not, to thereby charge the client PC.

The fundamental structure of the charging system of the fourth embodiment is therefore similar to that of the second embodiment. However, there are different points of the fourth embodiment. Namely, a counter of each apparatus constituting the input/output charging system is prepared also in accordance with a calibration function for the apparatus, and a different control method is incorporated.

The different points from the first and second embodiments will be described below.

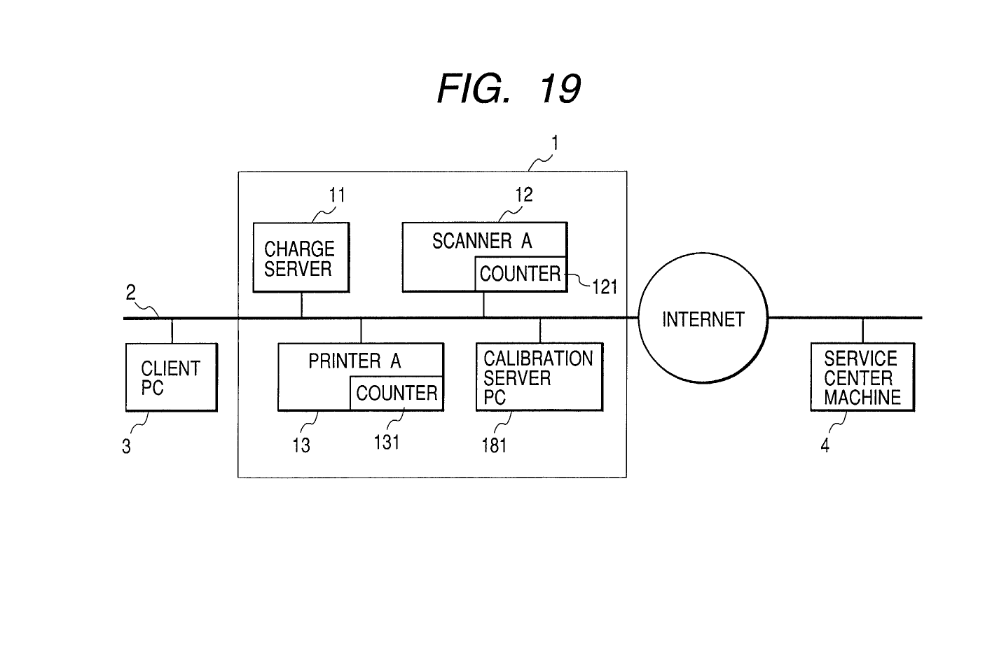

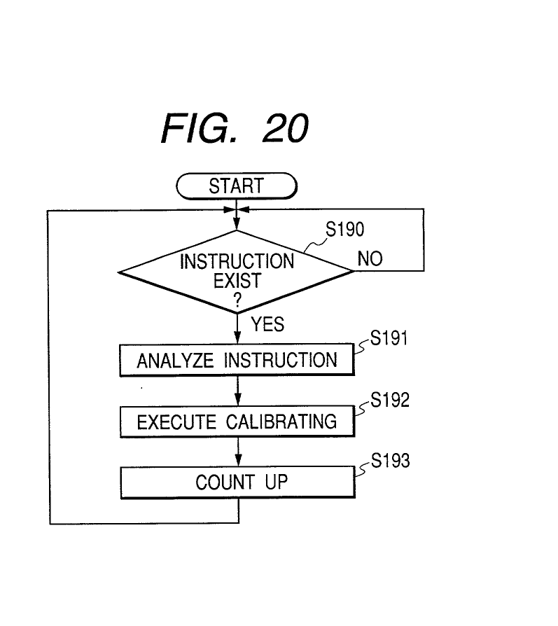

FIG. 19 is a block diagram showing the configuration of the charging system according to the fourth embodiment of the invention.

The configuration shown in FIG. 19 is the same as the first embodiment excepting that a calibration server PC 181 is added to the input/output charging system 1 and the composite apparatus 14 is omitted for the simplicity of description.

A process flow when the calibration server PC 181 performs a calibration operation in response to an instruction from the client PC 3 in this configuration shown in FIG. 19 will be described with reference to FIG. 20.

First, at Step S190 it is checked whether an instruction from the client flows on the network 2. If not, the flow returns to Step S190, whereas if the instruction flows on the network 2, the instruction is analyzed and the fact that which apparatus or apparatuses are subjected to the calibration is stored.

Next, at Step S192 a calibration process is executed for the apparatus to be calibrated. The details of the calibration process will be later given. Next, at Step S193 the count of the charge counter is renewed. This renewal is performed only for the counter of the calibrated apparatus.

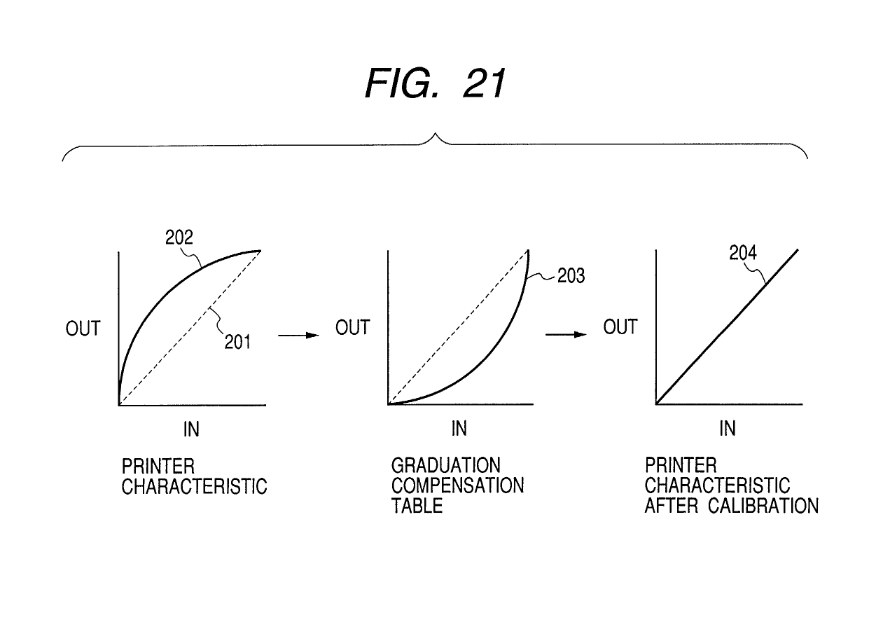

The details of calibration will be described. Calibration is performed basically in order to maintain the characteristics specific to the apparatus. Generally the characteristics of each apparatus when it is shipped from the factory change with environments such as a temperature and a humidity and with time. In a color apparatus in particular, color reproduction is influenced greatly even by a fine change in the color characteristics. Although calibration methods vary with the type of apparatuses such as scanners and printers, calibration will be described by taking as an example a printer, with reference to FIG. 21. Referring to FIG. 21, a line 201 indicates an ideal density characteristic of a printer. Since a printer generally uses toners of four colors CMYK, four kinds of density characteristics for CMYK exist. However, for the simplicity of description, only one characteristic will be described. The density characteristic becomes a curve 202 because of a change in color characteristics. To execute calibration is to change the characteristic 202 to the ideal characteristic 201. To this end, a gradation compensation table 203 is prepared. In this case, the gradation compensation table is formed by calculating an inverse function of the characteristic 202 because the ideal characteristic 201 is linear as shown in FIG. 21. However, the gradation compensation table may be formed through different calculations. The gradation compensation table is used during the printer color processing to cancel out the characteristics 202 and 203 so that an ideal characteristic 204 can be obtained.

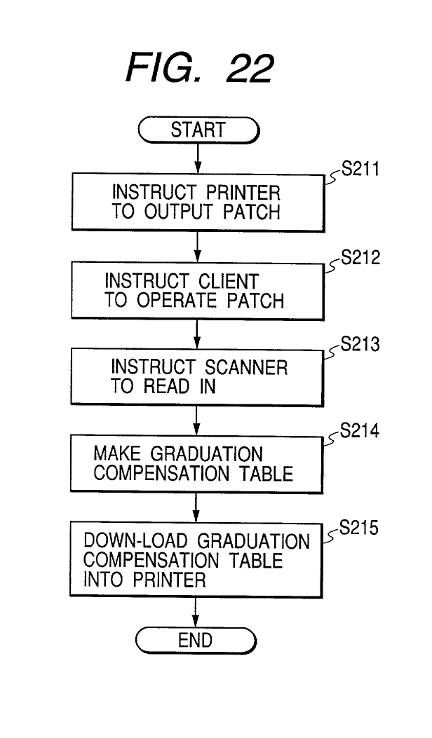

In this case, how the printer characteristic 202 is measured becomes an issue. In one method, the printer characteristic is obtained by mounting a density sensor on an unrepresented printer process controller and supplying the density values measured with the density sensor to a calibration server PC. However, there is a problem of a poor sensor precision and the like. In this embodiment, higher precision printer calibration is realized by using a printer and a scanner. In the configuration shown in FIG. 19, when a calibration of the printer A 13 is instructed by the client PC 3, the calibration is executed at Step S192 as described earlier. The calibration operation by the calibration server PC 181 will be described with reference to the flow chart shown in FIG. 22. At Step S211 the printer A is instructed to output a patch. A patch is an output which reflects the density characteristic, and generally uses gradation data for each of CMYK. In accordance with the instruction, the printer A 13 outputs the patch. Next, at Step S212 the client PC is instructed to perform a patch operation. This instruction urges a user to place the patch output from the printer A 13 on an original support of the scanner A 12. In accordance with this instruction, the client places the patch on the original support. Next, at Step S213 the scanner is instructed to read the patch. In accordance with this instruction, the scanner A scans the patch. The scanned signals are used as the printer characteristic 202 shown in FIG. 21. At Step S214, the gradation compensation table 203 shown in FIG. 21 is formed. Next, at Step S215 the gradation compensation table is down-loaded to the printer A 13. The printer A 13 performs a color processing by using the gradation compensation table so that the printer can output an image or text by using the ideal characteristic 204 shown in FIG. 21. The count-up at Step S193 shown in FIG. 20 is performed for the counter 131 of the printer A shown in FIG. 19.

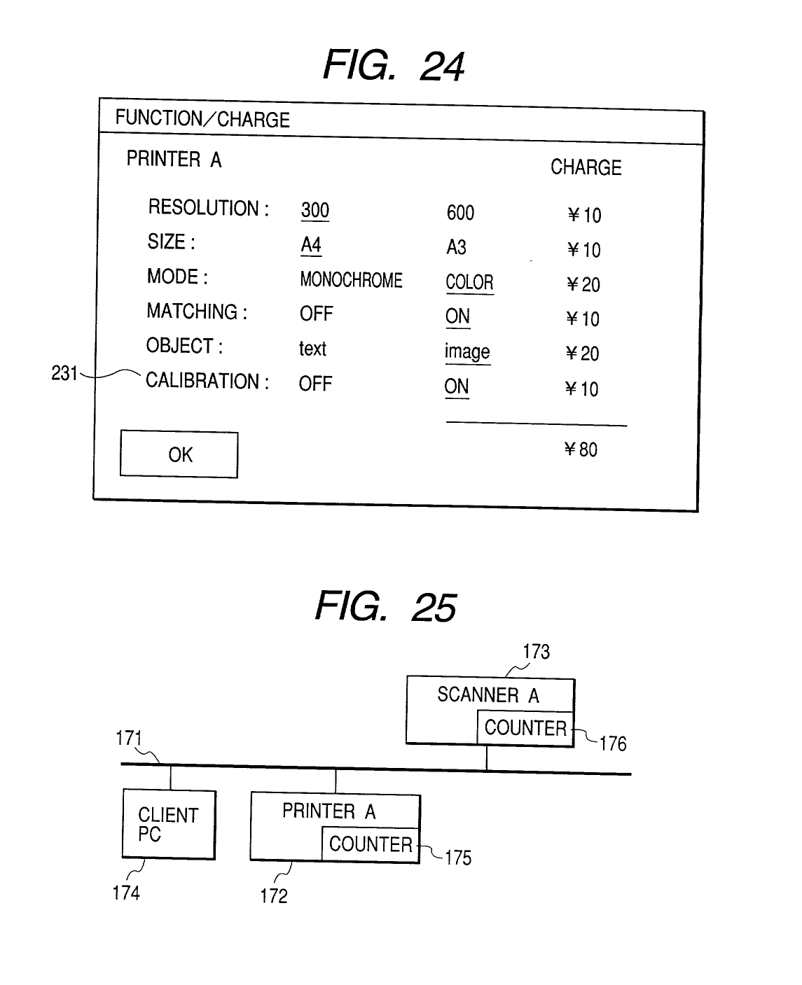

A display example of a user interface when the client PC 3 instructs to perform a calibration operation will be described with reference to FIG. 24. The display example shown in FIG. 24 is the same as the second embodiment excepting that an item “calibration” 231 is added. In this window, in addition to a correspondence between the functions of the printer A and the charges shown in the second embodiment, the calibration selection item 231 is displayed. The charges are calculated and displayed in accordance with the functions selected by a user. In the display example shown in FIG. 24, the functions selected are 300 dpi, A4, color mode, color matching-on, image included, and calibration-on which are given the charges of 10 Yen, 10 Yen, 20 Yen, 10 Yen, 20 Yen, and 10 Yen, respectively, totalling in 80 Yen. In the fourth embodiment, although the printer is used by way of example, similar operations are also performed when a scanner is used.

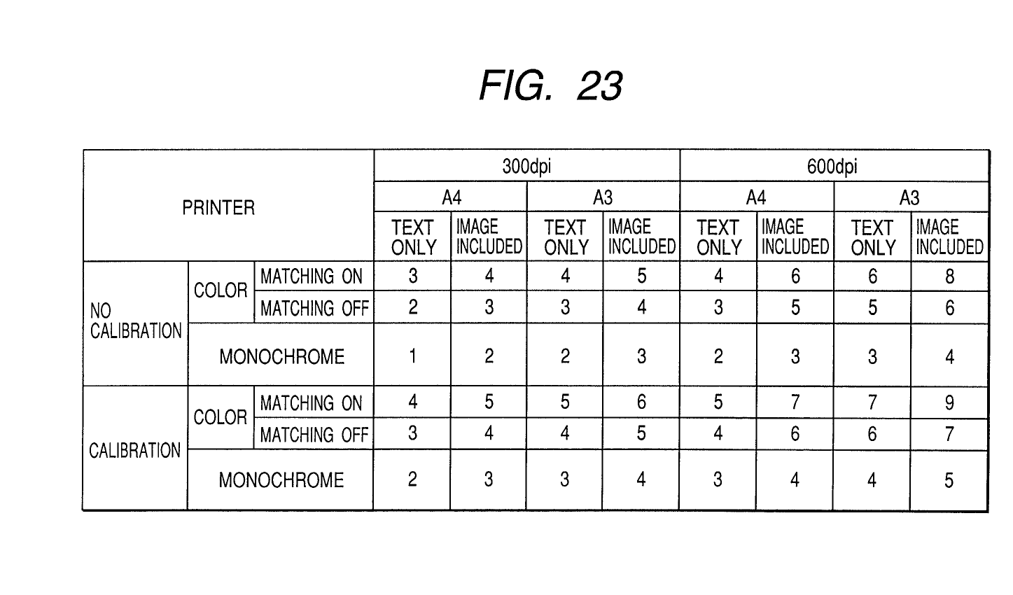

Similar to the second embodiment, the charge server 11 collects the counts corresponding the service contents as the charge information. In this case, the charge money is calculated by multiplying the count by a predetermined unit price for each service function. In this embodiment, the calibration-on/off item is added. A display example of unit price information for the calibration-on/off service function is shown in FIG. 23. FIG. 23 shows an example of a charge table of a printer. In this example shown in FIG. 23, for example a weight “5” is given for the set functions including calibration-on, color, matching-on, 300 dpi, A4, and image included. If the calibration-off is set, the weight changes to “4”. The unit prices of the charges are 50 Yen and 40 Yen which is a tenfold of the weights “5” and “4”. Although the charge table of the printer is shown in FIG. 23, the charge table of the scanner is formed in the similar manner.

As above, the count and the charge table for the service functions are used for charging each client.

The operation of the service machine 4 is similar to that of the second embodiment.

The processes similar to the first and second embodiments are performed by the input/output charging system 1 of the fourth embodiment, excepting that the count of a counter is renewed to charge each user in accordance with whether the calibration, which is different from the set items specific to each apparatus and is a service for stabilizing the operation environments of the apparatus, is used or not. Therefore, the description thereof is omitted.

In the fourth embodiment described above, in addition to the service contents of the second embodiment, the service contents more sophisticate than the second embodiment are used for renewing the count of the counter prepared for such sophisticate service contents to thereby charge each user. Accordingly, a fine charging system can be presented to a user and an efficient charging becomes possible.

The present invention may be applied to a system constituted by a plurality of apparatuses or to a system constituted by a single apparatus. It is obvious that the invention can be reduced in practice even when programs achieving the embodiment functions are supplied to a system or an apparatus. In this case, a storage medium storing such programs realizing the embodiment functions constitutes the invention. By reading the programs from the storage medium and writing them into a system or an apparatus, the system or apparatus operates in a predetermined manner.

According to the present invention, each apparatus constituting an input/output charging system connected on a network is provided with charge counters corresponding to detailed service contents instructed by a client and being discriminated for each client. The charge counters are renewed in accordance with the service contents requested by the client. A charge server as one constituent of the network periodically refers to the count of each charge counter of each apparatus. The network is also provided with a concentrated management server which collectively and periodically manages sum-up data constituted of the service contents, counts, and client information supplied from a plurality of charge servers. Accordingly, an efficient and fine charging can be performed.

As described so far, according to the present invention, a charging system for executing a process of charging for a use of each of a plurality of input/output apparatuses such as scanners and printers connected to a network is provided. The charging system comprises: a plurality of charge counters and renewing means provided for each of the plurality of input/output apparatuses, the plurality of charge counters being provided in correspondence with finely classified process contents of input/output processes, and the renewing means renewing the charge counters corresponding to the process contents of the input/output processes executed in response to an instruction from a computer connected to the network; a plurality of collecting means for collecting counts of the charge counters of the plurality of input/output apparatuses, the counts having been renewed by the renewing means; and means for collecting and collectively managing the counts of the charge counters collected by the plurality of collecting means together with information representative of the corresponding collection means and information representative of the corresponding process contents of the input/output processes. Accordingly it is not necessary for a service man to routinely go to each client and check and sum up the counts of respective counters, and the cost of man power can be reduced and an efficient and fine charge work can be realized in accordance with the service contents.

What is claimed is:

1. A charging system for executing a process of charging for a use of each of a plurality of input/output apparatuses such as scanners and printers connected to a network, the charging system comprising:
a single charge counter and renewing means provided for each of the plurality of input/output apparatuses, said renewing means renewing said charge counter when an input/output process is executed in response to an instruction from a computer connected to the network; and
summing means for summing up counts of said charge counters of the plurality of input/output apparatuses, the counts having been renewed by said renewing means.

2. A charging system according to claim 1, wherein a plurality of summing means are provided and the charging system further comprises managing means for collecting and collectively managing the sum-up results generated by the plurality of summing means.

3. A charging system for executing a process of charging for a use of each of a plurality of input/output apparatuses such as scanners and printers connected to a network, the charging system comprising:
a single charge counter and renewing means.
